(19) United States
(12) Patent Application Publication
(10) Pub. No.: US 2026/0127591 A1
(43) Pub. Date: May 7, 2026

(54) METHOD FOR TOKEN TRANSACTION USING SMART CONTRACTS BASED ON BLOCKCHAIN TECHNOLOGY

(71) Applicant: KOLIBRI GMBH, Eschborn (DE)

(72) Inventors: Luca Felix OFFER, Groß-Gerau (DE); Fabian ECKART, Groß-Gerau (DE)

(21) Appl. No.: 19/118,294

(22) PCT Filed: Oct. 13, 2023
(86) PCT No.: PCT/EP2023/078577

§ 371 Date: Apr. 3, 2025

(30) Foreign Application Priority Data
Oct. 19, 2022 (EP) 22202552

(51) Int. Cl. G06Q 20/38; G06Q 20/32; G06Q 20/36

(52) U.S. Cl. CPC G06Q 20/389; G06Q 20/326; G06Q 20/36; G06Q 20/381

(57) ABSTRACT

The present invention relates to a method for processing a digital transaction comprising: receiving, by an issuer system in electronic communication with a smart contract, a transfer notification comprising a user's public blockchain address associated with the user's electronic wallet, a service provider's public blockchain address associated with the service provider's electronic wallet, and a transaction amount;
the issuer system in electronic communication with the smart contract receiving the x first token(s) corresponding to the transaction amount from the user's electronic wallet and sending the transaction amount in form of an amount of y second token(s) corresponding to the transaction amount to the service provider's electronic wallet.

The present invention relates to a method for token transactions using smart contracts based on blockchain technology.

A blockchain is a distributed and public ledger which maintains records of all the transactions. A blockchain network is a truly peer-to-peer network and it does not require a trusted central authority or intermediaries to authenticate or to settle the transactions or to control the network infrastructure.

Users can interact and transact with the blockchain networks through Externally Owned Account (EOAs), which are owned and controlled by the users. Such an EOA is as well as known as an “electronic wallet”. Each electronic wallet or EOA has a balance (in certain units of a Cryptocurrency associated with the Blockchain network) associated with it. EOAs do not have any associated code. All transactions on a blockchain network are initiated by EOAs. These accounts can send transactions to other EOAs or contract accounts.

Another type of accounts support by second generation programmable Blockchain platforms are the Contract Accounts. A Contract Account is created and owned by an EOA and is controlled by the associated contract code which is stored with the account. Such contracts are as well known as “smart contracts”. The contract code execution is triggered by transactions sent by EOAs or messages sent by other contracts.

Subsequently, the terms “smart contract” and “electronic wallets” are used for the above stated definitions subsequently to describe the scope of the present invention.

Blockchain networks can either be public or private. Public blockchain networks are free and open to all and any user can create an account and participate in the consensus mechanism on a public blockchain and view all the transactions on the network. Private blockchain networks are usually controlled and operated by a single organization and the transactions can be viewed only by the users within the organization.

Public blockchain networks are usually unpermissioned or permissionless, as any node can participate in consensus process. Some public blockchain networks adopt a permissioned model where the consensus process is controlled by a pre-selected set of nodes.

Private blockchain networks usually adopt the permissioned model. While public blockchain networks can be considered as fully decentralized, private blockchain networks are partially decentralized.

Organizations can have multiple private blockchain networks where each network is dedicated to a specific use case or department or business vertical. The blockchain networks within an organization may be created either using the same blockchain platform or technology or with different platforms or technologies.

On each blockchain network, a user can create multiple elecotrnic wallets. Each electronic wallet has a public-private keypair associated with it. The account address is derived from the public key. When a new electronic wallet is created, a keyfile is created which has the public and private keys associated with the account.

The private key is encrypted with the password which is provided while creating the account. For sending transactions to other accounts, the private key and the account password are required.

Based on blockchains, tokens can be created that looks and feel for the user as the native blockchain token, but is just a derviate of the actual block chain.

An example of such tokens are ERC20 tokens which are built on the Etherium Blockchain and ERC-721 token for non-fungible tokens (NFTs).

The present invention aims on a method of using tokens on an existing blockchain to allow payments between entities, in particular between users and service providers. Of course, it may be possible that a new blockchain may be created as a basis of the invention and this is not excluded from the present disclosure.

A payment refers to the liquidation of the bond/debt relationship between the parties to a transaction, which arises from various economic activities and financial transactions, through the transfer of monetary value. In the present case, in particular the transfer of a specific amount of money from a user in exchange for a good or service provided by a service provider.

A payment service is the movement of money between economic entities and financial institutions. Users, who are economic agents, use payment services provided by payment service providers such as banks and credit card companies that provide payment services in order to make payments to service providers that provide services.

However, payment services provided by payment service providers such as banks and credit card companies include online authentication companies, payment agencies (PG companies; payment gateway companies), and VAN companies that perform various auxiliary services between service providers and payment service providers.

This is a complex, not always user friendly, and expensive process.

In addition, in the conventional card payment network, since the user's personal information and card information for payment approval are transmitted on/offline, there is a problem in that information exposure by hacking or the like and card theft using the same may occur.

Accordingly, in the present invention, it is intended to provide a payment system that can be used for payment without using an existing credit or debit card payment network.

This problems stated above are solved by a method for processing a digital transaction comprising:
receiving, by an issuer system in electronic communication with a smart contract, a transfer notification comprising a user's public blockchain address associated with the user's electronic wallet, a service provider's public blockchain address associated with the service provider's electronic wallet, and a transaction amount;
the issuer system in electronic communication with the smart contract receiving the x first token(s) corresponding to the transaction amount from the user's electronic wallet and sending the transaction amount in form of an amount of y second token(s) corresponding to the transaction amount to the service provider's electronic wallet.

The surprising finding of the present invention is that it is possible to split one blockchain token transaction into two parts of token transfers of two different tokens with the help of a smart contract.

Blockchain payments have one big disadvantage: Most crypto currencies have no fixed values against fiat money like Euro or US-Dollar. This is desired for speculative investments by investors, but of disadvantage when it comes to actual payments.

The service provider don't want to change prices on a minutely basis in cryptocurrencies and the user intends to compare the pricing of goods and services to the value in fiat money. An example of a service provider according to the present disclosure is a merchant.

Even though a fast and easy payment with crypto currency with all advantages of the same like e.g. transaction time and costs would be possible, due to the disadvantages state above there are hardly any payment options provided so far by service providers in crypto currencies.

The general scope of the present invention is therefore to allow a service provider to get paid in a stable value token, while the user may pay in a more volatile token, while a smart contract balances the tokens and proceeds the payments automatically. The term service provider shall be understood broadly in the present disclosure and shall comprise any receivers of payment transactions.

Therefore, an issuer system in electronic communication with a smart contract is provided. Said issuer system comprise an own smart wallet in connection with the smart contract. Once the user wants to start a transfer, a transfer notification comprising a user's public blockchain address associated with the user's electronic wallet, a service provider's public blockchain address associated with the service provider's electronic wallet, and a transaction amount is processed by the issuer system.

This information is the basis for the handling of payments on a blockchain. The issuer system must now how is paying whom which amount of money.

According to the present disclosure, the issuer system receives x first token(s) corresponding to the transaction amount. This may be a volatile token. After receiving the respective amount of first token(s), the issuer system is sending a corresponding amount of second token(s) to the service providers electronic wallet. Preferably, said second token is much less volatile than the first token.

Within the method of the present invention it may be preferred that the issuer system gets permission to execute transaction from and to the user's and service provider's electronic wallet.

To interact with smart contracts, each electronic wallet can give permissions to smart contracts for transactions. This may be the right to transfer a certain number of tokens from the respective electronic wallet to another electronic wallet, either without limitation or within given boundaries.

For being able to estimate the value of the first and the second token relative to each other or to another reference value, it may be of advantage that the issuer system in electronic communication with the smart contract retrieves the value of the first token in relation to the second token via the smart contract and/or from one or more centralized and/or decentralized exchange, wherein in particular said relation is an exchange rate of the first and second token.

To be able to process a payment, a method according to the present invention retrieves the value of the first and second token relative to each other either by the smart contract itself or pay comparing the same with the respective values of the tokens relative to a further token.

According to one embodiment of the present disclosure it may be preferred that the second token is a token coupled in a specific range to a fiat money currency, in particular to a range >1% deviation of the fiat money currency in 99.9% of time.

For a service provider it is of advantage that the value in fiat money the receiving number of tokens is predictable. Therefore, it may be preferred that the second token is a so called “stable coin”, which is a token that is in a fixed price range to a fiat currency.

Please note that the remarkable discovery made in the current invention stands in stark contrast to trading and transaction systems known in the state of the art. Unlike conventional setups where tokens are directly exchanged between two parties, such as a user and a service provider, the novel approach disclosed in this application differs significantly. In typical scenarios following the existing state-of-the-art, smart contracts execute transactions by transferring a quantity of token A from one wallet (wallet 1) to another (wallet 2), and reciprocally, a quantity of token B from wallet 2 to wallet 1. This exchange could be immediate or mediated through a decentralized exchange (DEX).

To illustrate, consider a situation in which a user wishes to purchase a service from a service provider. The service provider may initially accept payment in the form of a cryptocurrency like Bitcoin. However, in the long term, the service provider requires fiat currency such as USD or EUR. At the time of the transaction, the service provider receives an amount of Bitcoin equivalent to the desired USD amount. These Bitcoins are transferred from the user's wallet to the service provider's wallet. Subsequently, the service provider must sell the Bitcoin on a centralized or decentralized exchange. Due to the inherent volatility of cryptocurrencies, the received USD amount is likely to differ from the originally agreed-upon amount at the time of the initial transaction.

In contrast, under the current invention, the user sends the Bitcoin to the smart contract, and the smart contract directly disburses the specified amount of USD to the service provider e.g. in form of a stable coin. Consequently, there is no risk of an unfavorable exchange rate fluctuation occurring at a later stage.

Furthermore, it may also be preferable, according to this invention, for the transaction to occur within the same block of transactions. This ensures the elimination of any exchange rate fluctuations, providing an additional layer of stability to the process.

Another example according to the present invention is that physical asset can be paired in the smart contract with a value in a FIAT currency. It is possible that a user couples a NFT representation of a physical asset in the smart contract having a fixed value because the transaction is happening at once and preferably in the same block.

Certainly, “white labeling” is a practice where a company or service provider offers their products or services to other businesses, who can then rebrand and market those products or services as if they were their own. In essence, it allows businesses to leverage existing offerings without having to invest heavily in developing their own from scratch.

The present invention also extends to the provision of “white labeling” solutions. This means that businesses have the option to utilize the innovative approach and technology to offer their own customized products or services under their brand identity. This can significantly expedite their market entry and expansion efforts, while the value pairing is happening in the background by the innovative smart contract. According to a further embodiment of the present disclosure, it may be preferred that the issuer system is comprising a database of authorized service providers and each authorized service provider a unique service provider identifier is assigned with the respective authorized service provider, wherein the unique service provider identifier is the public blockchain address of the service provider and/or a identifier representative for the service provider linked with said public blockchain address.

Thereby it can be of advantage, that the issuer systemin electronic communication with the smart contract, once a transfer notification is received, checks whether a transaction is established between a user and an authorized service provider, and, if this is true, the issuer systems sends z % of the tokens received from the user back to the user's electronic wallet.

To offer a bonus system may be of advantage. The technical problem to be solved is how to make sure that the system works without any misuse. This problem is solved by offering paybacks to the user for transactions made with registered service providers.

As well, it may be preferred according to one embodiment of the present disclosure that the smart contract interacts with a smart contract wallet comprising an amount A of first tokens and an amount B of second tokens, wherein the smart contract wallet is capable of sending and receiving first and second tokens to other electronic wallets, in particular to user and service provider wallets.

As stated above, each smart contract is associated with an electronic wallet to be able to interact with the blockchain. It may be of advantage if this smart wallet—or a further smart wallet—is connected with the smart wallet to work as a liquidity pool provider.

It may the as well be preferred that the service provider's electronic wallet interacts with a further smart contract or a software program, wherein each time the service provider receives an amount of y of second tokens and/or at predefined dates and times and/or in specific time intervals, e.g. daily, weekly, monthly and/or once a certain threshold value is reached, the amount of second tokens stored in the service providers wallet is sold on a centralized and/or decentralized exchanged and it is requested to pay out the respective amount of fiat money received to the service providers bank account.

Thereby, it can be of advantage that the service provider is registered at a centralized and/or decentralized exchange having an established electronic transfer process to the service provider's bank account.

This allows a direct connection from the blockchain technology to the traditional backing system.

According to a further embodiment of the present disclosure, a mobile wallet application is provided on a mobile devices of the user which is connected with the user's wallet and is capable of receiving information from the user's wallet, wherein the user is able to confirm and deny transaction via this mobile wallet application, and wherein
the mobile wallet app is connected with a financial service provider application, said financial service provider application is connected to a bank account, a debit card, a credit card and/or another electronic wallet of the user.

Thereby it may be preferred that if the transaction amount exceeds the amount of first tokens in the user's wallet, the financial service provider application charges the bank account, the debit card and/or the credit card of the user to buy the respective amount of first tokens needed for completing the transaction and forward said to the user's wallet or transfers the amount of first tokens needed from the user's further wallet.

To ease the use for the user it may be preferred that in case the user does not has the number of tokens needed to proceed with the transaction, the needed amount is bought automatically by the system.

Thereby it may be of advantage according to one embodiment of the present disclosure to provide an option for collaboration with issuers, including both external issuers and internal issuers, to accommodate third-party currencies within the infrastructure or situations where the corporate group possesses the requisite licensing to issue stablecoins or similar digital assets, in particular utilizing their corresponding infrastructure for transaction processing.

Banks typically operate under stringent regulatory frameworks. Partnering with banks ensures compliance with financial regulations, which is crucial for any payment system to gain legitimacy and avoid legal complications. As well, banks are well-established financial institutions with extensive networks. Integrating with banks allows for seamless interoperability between traditional banking systems and the new payment system, enabling users to easily transition between fiat currencies and cryptocurrencies.

Collaborating with banks can help bridge the gap between traditional financial services and the emerging cryptocurrency landscape. This can accelerate user adoption, as people are more likely to trust and use a payment system that is connected to their existing financial institutions. Banks can provide liquidity to the payment system, ensuring that users can easily convert their assets between cryptocurrencies and fiat currencies. This liquidity is essential for the smooth functioning of the payment ecosystem.

Therefore it may be of advantage for the disclosed method to collaborate with issuers of of stable coins and other coins and tokens and/or banks. collaborating with banks within the payment system can enhance its stability, security, and utility, making it more attractive to a wider audience and strengthening its position in the evolving financial landscape.

According to one embodiment of the present disclosure, a shop software is provided on a server, the shop software being connected to the issuer system, wherein a token pay button for payment of the first token is comprised to let users pay directly witch first tokens while the service provider receive second tokens and/or a payment in fiat money to his bank account.

The easiest way to implement the innovative payment solution described above is to provide a pay button that activates all functions described above automatically.

The inventive method may therefore comprise the following steps, in particular in this order
a) a user selects the token pay button to pay for his purchase or starts a payment with the help of a QR-Code or a NFC-payment method;
b) the issuer system issues and transfer notification comprising the user's public blockchain address associated with the user's electronic wallet, the service providers public blockchain address associated with the service provider's public wallet and the transaction amount;
c) transferring the x first token(s) corresponding to the transaction amount from the user's electronic wallet to the smart contract wallet and sending the transaction amount in form of an amount of y second token(s) corresponding to the transaction amount from the smart contract wallet to the service provider's electronic wallet.

When it comes to initiating a payment process, the disclosed innovation offers versatile options that cater to diverse user preferences and technological advancements. These methods seamlessly integrate with our system, ensuring a frictionless payment experience.

One straightforward approach is the implementation of a “Pay” button. Users can simply click or tap on this button, initiating the payment process without hassle. This intuitive method is particularly effective for online transactions and e-commerce platforms, streamlining the checkout process.

Additionally, Near Field Communication (NFC) technology presents another convenient option. With NFC-enabled devices, users can make payments by bringing their device close to a compatible point-of-sale terminal or another NFC-enabled device. This touchless and secure method is becoming increasingly popular for in-person transactions, ensuring swift and contactless payments.

For those seeking an even more efficient means of initiating payments, Quick Response (QR) codes come into play. Users can scan a QR code displayed by the service provider or seller, instantly triggering the payment process. This method is particularly advantageous for mobile payments, as it eliminates the need for manual data entry and minimizes errors. In addition to the innovative method, the innovation provides as well a related computer-based system for processing transactions, in particular a method according to one of the preceding claims, comprising:
a processor; and a tangible, non-transitory memory configured to communicate with the processor, the tangible, non-transitory memory having instructions stored thereon that, in response to execution by the processor, cause an issuer system to perform operations comprising:
receiving, by an issuer system in electronic communication with a smart contract, a transfer notification comprising a user's public blockchain address associated with the user's electronic wallet, a service provider's public blockchain address associated with the service provider's electronic wallet, and a transaction amount;
the issuer system in electronic communication with the smart contract receiving the x first token(s) corresponding to the transaction amount from the user's electronic wallet and sending the transaction amount in form of an amount of y second token(s) corresponding to the transaction amount to the service provider's electronic wallet.

Preferably, said system further comprises a mobile device associate with a user capable of running a mobile wallet application.

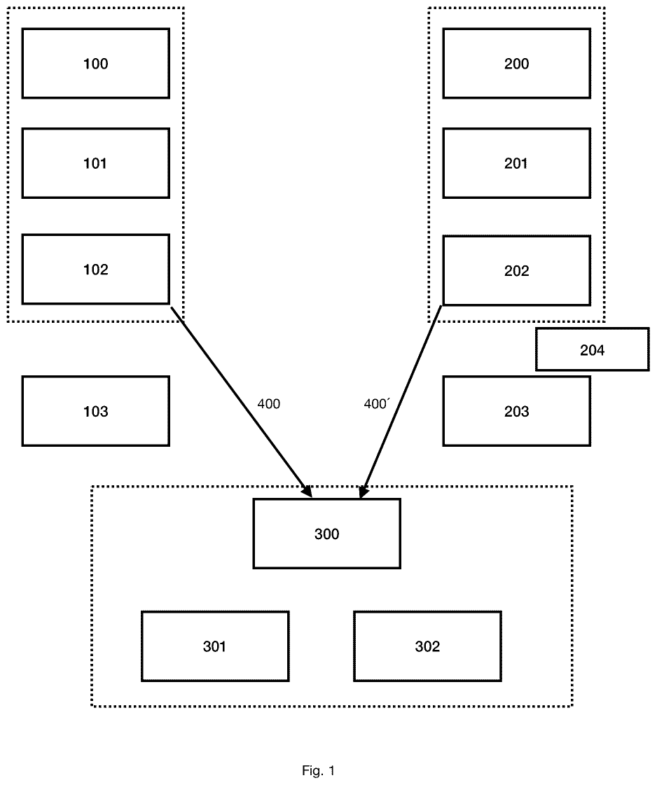

The foregoing aspects and many of the attendant advantages of this invention will become more readily appreciated as the same become better understood by reference to the following detailed description, when taken in conjunction with the accompanying drawing, wherein:
FIG. 1 is a schematic block diagram of an example of the method according to an embodiment.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

While illustrative examples are illustrated and described below, it will be appreciated that various changes can be made therein without departing from the spirit and scope of the disclosure. In that regard, the detailed description set forth below, in connection with the appended drawings is intended only as a description of various examples of the disclosed subject matter and is not intended to represent the only examples. Each example described in this disclosure is provided merely as an example or illustration and should not be construed as preferred or advantageous over other examples. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

FIG. 1 shows a diagram 100 illustrating an exemplarily example of the method according to the present disclosure.

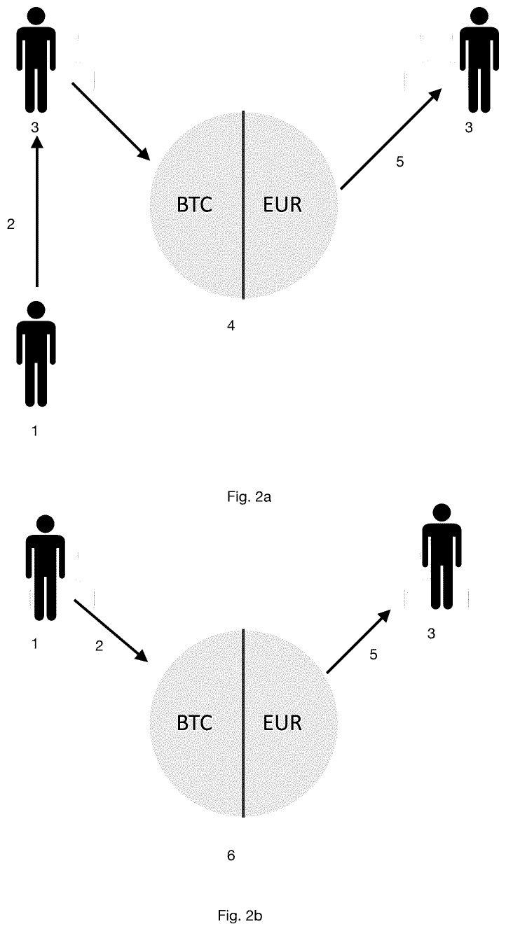

FIGS. 2a and 2b shows a diagram each illustrating the difference of the state of the art and the present disclosure in a top level view.

For the method, according to this example, at least one smart contract connectable to at least one electronic wallet of a user and at least one electronic wallet is provided.

A user 100 is owner of a bank account 101 for storing fiat money and of an electronic wallet 102 for blockchain transaction. A service provider 200 owns a bank account 201 and as well an electronic wallet 202.

Furthermore, the user 100 owns a mobile device 103 and the service provider an online-shop 203.

The issuer system 300 is in electronic communication with a smart contract 301 and an electronic wallet 302 acting as a liquidity pool and serving as a basis for the smart contract 301.

In the first method step, the user's electronic wallet 102 starts a transaction 400 in case a respective “pay” button is selected by the user 100 in the onlineshop 203 of the service provider.

To start the interaction, the user's smart wallet 102 interacts with the issuer system 300, in particular with the smart contract 301 of the issuer system.

The issuer system 300 receives from the service provider the public blockchain address of its wallet 202 and the respective transaction amount 400′ and the user's electronic wallet public blockchain address 400.

Subsquent, the smart contract 300 requests a token transaction from the user's electronic wallet 102 with the amount of first tokens needed for completing the transaction and stores them in the respective electronic wallet 302 and sends a number of second tokens from the electronic wallet 302 to the service providers electronic wallet 202.

In the next step, or prior to this step, the smart contract 300 checks whether the service provider is a listed service provider. If correct, the smart contracts causes the electronic wallet 302 to send a pre-defined percentage of first tokens back to the user's electronic wallet 102.

By the help of a separate software-or being part of the smart contract itself —the second tokens in the electronic wallet 202 are changed to fiat money at defined intervals, e.g. on a daily bases. This is executed by selling them on a centralized or dezentralized exchange for fiat money. The received fiat money is than transferred to the service provider's bank account 201 by the software automatically.

With the help of this innovative method, a payment solution is possible which allows a service provider to be paid in crypto tokens, while from a practical perspective the service provider receives fiat money on his bank account only directly.

In case that the user's wallet has an insufficient amount of first tokens stored, with the help of an application 103 installed on a user's mobile device which is connected to his electronic wallet 102 and has an interface with a decentralized or centralized exchange, the needed number of first tokens may be bought automatically to complete the transaction and charge the buying amount in fiat money to the user's bank account 101.

FIG. 2 a shows a method according to the state of the art. If a person 1 wants to buy with a crypto currency 2 from a service provider 3, the crypto currency 2 is transfer from said first person's 1 wallet to the service provider 3 wallet. In the long run, the service provider is interested in changing the crypto currency 2 into FIAT money or a stable coin. Therefore the service provider is interacting with an exchange 4 (either centralized or decentralized) and receives for sending the crypto coins 2 either FIAT money 6 or another crypto coin 6.

This exchange process has the problem of volatile exchange rates and volatile additional fees (for the exchange and gas fees).

According to the present disclosure, this problem is solved in a technical way. The user 1 sends crypto coins 2 to the smart contract 6 and the service provider 3 receives from the smart contract the desired coins (FIAT or stable coins or other) directly without any additional risks of losses. If this is processed within one block on a blockchain, the initial display values of the transaction can be guaranteed, so it is preferred that the smart contract handles both transaction within one block.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and method steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

1. A method for processing a digital transaction comprising:
receiving, by an issuer system in electronic communication with a smart contract, a transfer notification comprising a user's public blockchain address associated with the user's electronic wallet, a service provider's public blockchain address associated with the service provider's electronic wallet, and a transaction amount;
the issuer system in electronic communication with the smart contract receiving the x first token(s) corresponding to the transaction amount from the user's electronic wallet and sending the transaction amount in form of an amount of y second token(s) corresponding to the transaction amount to the service provider's electronic wallet.

2. A method according to claim 1, further comprising
the issuer system gets permission to execute transaction from and to the user's and service provider's electronic wallet, and wherein no direct transaction from between the user's and the service provider's wallet happens, but from the user to the smart contract's wallet and from the smart contract's wallet to the service provider

3. A method according to claim 1, further
the issuer system in electronic communication with the smart contract retrieves the value of the first token in relation to the second token via the smart contract and/or from one or more centralized and/or decentralized exchange, wherein in particular said relation is an exchange rate of the first and second token.

4. A method according to claim 1, further comprising the following step:
the second token is a token coupled in a specific range to a fiat money currency, in particular to a range >1% deviation of the fiat money currency in 99.9% of time.

5. A method according to claim 1, further comprising the following step:
the issuer system comprising a database of authorized service providers and each authorized service provider a unique service provider identifier is assigned with the respective authorized service provider, wherein the unique service provider identifier is the public blockchain address of the service provider and/or a identifier representative for the service provider linked with said public blockchain address.

6. A method according to claim 1, wherein
the issuer systemin electronic communication with the smart contract, once a transfer notification is received, checks whether a transaction is established between a user and an authorized service provider, and, if this is true, the issuer systems sends z % of the tokens received from the user back to the user's electronic wallet.

7. A method according to claim 1, wherein
the smart contract interacts with a smart contract wallet comprising an amount A of first tokens and an amount B of second tokens, wherein the smart contract wallet is capable of sending and receiving first and second tokens to other electronic wallets, in particular to user and service provider wallets.

8. A method according claim 1, wherein
the service provider's electronic wallet interacts with a further smart contract or a software program, wherein each time the service provider receives an amount of y of second tokens and/or at predefined dates and times and/or in specific time intervals, e.g. daily, weekly, monthly and/or once a certain threshold value is reached, the amount of second tokens stored in the service providers wallet is sold on a centralized and/or decentralized exchanged and it is requested to pay out the respective amount of fiat money received to the service providers bank account.

9. A method according to claim 7, wherein
the service provider is registered at a centralized and/or decentralized exchange having an established electronic transfer process to the service providers bank account.

10. A method according to one of the preceding claims claim 1, wherein
a mobile wallet application is provided on a mobile devices of the user which is connected with the user's wallet and is capable of receiving information from the user's wallet, wherein the user is able to confirm and deny transaction via this mobile wallet application, and wherein
the mobile wallet app is connected with a financial service provider application, said financial service provider application is connected to a bank account, a debit card, a credit card and/or another electronic wallet of the user.

11. The method according to claim 9, wherein
if the transaction amount exceeds the amount of first tokens in the user's wallet, the financial service provider application charges the bank account, the debit card and/or the credit card of the user to buy the respective amount of first tokens needed for completing the transaction and forward said to the user's wallet or transfers the amount of first tokens needed from the user's further wallet.

12. The method according to claim 9, wherein
providing an option for collaboration with issuers, including both external issuers and internal issuers, to accommodate third-party currencies within the infrastructure or situations where the corporate group possesses the requisite licensing to issue stablecoins or similar digital assets, in particular utilizing their corresponding infrastructure for transaction processing.

13. The method according to claim 1, wherein
a shop software is provided on a server, the shop software being connected to the issuer system, wherein a token pay button for payment of the first token is comprised to let users pay directly witch first tokens while the service provider receive second tokens and/or a payment in fiat money to his bank account.

14. The method according to claim 1, comprising the following steps, in particular in this order
a) a user selects the token pay button to pay for his purchase an/or starts a payment with the help of a QR-Code or a NFC-payment method and/or the payment process is started via an API
b) the issuer system issues and transfer notification comprising the user's public blockchain address associated with the user's electronic wallet, the service providers public blockchain address associated with the service provider's public wallet and the transaction amount;
c) transferring the x first token(s) corresponding to the transaction amount from the user's electronic wallet to the smart contract wallet and sending the transaction amount in form of an amount of y second token(s) corresponding to the transaction amount from the smart contract wallet to the service provider's electronic wallet.

15. A computer-based system for processing transactions, in particular a method according to claim 1, comprising:
a processor; and a tangible, non-transitory memory configured to communicate with the processor, the tangible, non-transitory memory having instructions stored thereon that, in response to execution by the processor, cause an issuer system to perform operations comprising:
receiving, by an issuer system in electronic communication with a smart contract, a transfer notification comprising a user's public blockchain address associated with the user's electronic wallet, a service provider's public blockchain address associated with the service provider's electronic wallet, and a transaction amount;
the issuer system in electronic communication with the smart contract receiving the x first token(s) corresponding to the transaction amount from the user's electronic wallet and sending the transaction amount in form of an amount of y second token(s) corresponding to the transaction amount to the service provider's electronic wallet.

16. The computer-based system according to claim 14, further comprising:
a mobile device associate with a user capable of running a mobile wallet application.
